(19) United States
(12) Patent Application Publication
(10) Pub. No.: US 2021/0133933 A1
(43) Pub. Date: May 6, 2021

(54) IMAGE PROCESSING APPARATUS AND IMAGE PROCESSING METHOD

(71) Applicant: CANON KABUSHIKI KAISHA, Tokyo (JP)

(72) Inventor: Hiroshi Suzuki, Kanagawa (JP)

(21) Appl. No.: 17/083,044

(22) Filed: Oct. 28, 2020

(30) Foreign Application Priority Data
Oct. 31, 2019 (JP) 2019-199242

(51) Int. Cl. G06T 5/00; G06T 5/20

(52) U.S. Cl. CPC G06T 5/002; G06T 5/007; G06T 5/20; G06T 5/003

(57) ABSTRACT

An image processing apparatus comprises an image processing unit configured to apply image processing to image data; communication unit configured to communicate with an external apparatus; and a control unit configured to control whether image processing for the image data is to be applied at the image processing unit or at the external apparatus, based on content of the image processing or an amount of data to be communicate with the external apparatus.

### BACKGROUND OF THE INVENTION

### Field of the Invention

The present invention relates to an image processing apparatus and an image processing method.

### Description of the Related Art

There are techniques for executing image processing at a higher speed than the maximum speed at which a terminal device performs the image processing, by entrusting the image processing to an external apparatus that is communicably connected to the terminal device and has the required image processing speed (Japanese Patent Laid-Open No. 2007-128250).

Every time image processing is to be entrusted to an external apparatus, image data to be processed needs to be transmitted/received to/from the external apparatus. The larger the data amount of the image data is the longer the time required for transmission/receiving the data becomes. In particular, if the external apparatus is on a shared network the time required for transmitting/receiving the image data will vary depending on the traffic situation of the shared network, the time required for transmitting/receiving the image data becoming longer with increased traffic on the shared network. On the other hand, when all the image processing is applied by the terminal device, the time required for the image processing becomes very long depending on the processing capacity of the terminal device, and there is the possibility that the usability will decrease.

### SUMMARY OF THE INVENTION

According to one mode of the present invention, an image processing apparatus and an image processing method that make it possible to appropriately entrust image processing to an external apparatus are provided.

According to an aspect of the present invention, there is provided an image processing apparatus comprising: one or more processors that execute a program stored in a memory to function as: an image processing unit configured to apply image processing to image data; a communication unit configured to communicate with an external apparatus; and a control unit configured to control whether image processing for the image data is to be applied at the image processing unit or at the external apparatus, based on content of the image processing or an amount of data to be communicate with the external apparatus.

According to another aspect of the present invention, there is provided an image processing method that is executed by an image processing apparatus that includes an image processor that applies image processing to image data, the method comprising controlling whether image processing for the image data is to be applied at the image processor or at an external apparatus with which the image processing apparatus can communicate, based on content of the image processing or an amount of data to be communicated with the external apparatus.

According to a further aspect of the present invention, there is provided a computer-readable medium that stores a program causing a computer to function as an image processing apparatus comprising: an image processing unit configured to apply image processing to image data; a communication unit configured to communicate with an external apparatus; and a control unit configured to control whether image processing for the image data is to be applied at the image processing unit or at the external apparatus, based on content of the image processing or an amount of data to be communicate with the external apparatus.

Further features of the present invention will become apparent from the following description of exemplary embodiments (with reference to the attached drawings). Each of the embodiments of the present invention described below can be implemented solely or as a combination of a plurality of the embodiments. Also, features from different embodiments can be combined where necessary or where the combination of elements or features from individual embodiments in a single embodiment is beneficial.

### BRIEF DESCRIPTION OF THE DRAWINGS

FIG. 1 is a schematic diagram showing a configuration example of an image processing system according to an embodiment of the invention.

FIG. 2 is a block diagram showing an exemplary function configuration of a PC 101 according to an embodiment of the invention.

FIG. 3 is a flowchart related to operations of the PC 101 and a server 103 according to an embodiment of the invention.

FIGS. 4A and 4B are diagrams illustrating examples of image editor GUIs of the PC 101 according to an embodiment of the invention.

FIGS. 5A to 5C are diagrams related to data formats of image data according to a second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

Note that, in embodiments below, a case will be described in which the present invention is carried out using a computer apparatus (personal computer, tablet computer, media player, PDA, etc.). However, the present invention is applicable to any electronic apparatus that can be connected to a network. Such an electronic apparatus may be a digital (video) camera, a mobile phone, a smartphone, a game machine, a robot, a drone, a drive recorder, or the like. These are exemplary, and the present invention is also applicable to other electronic apparatuses.

### First Embodiment

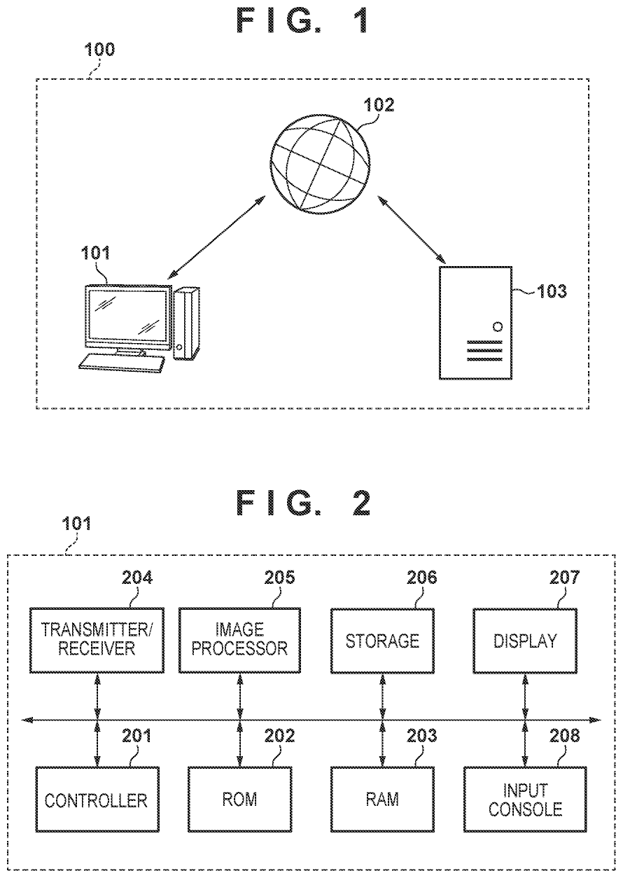

FIG. 1 is a schematic diagram related to a configuration of an image processing system 100 according to a first embodiment of the present invention. The image processing system 100 has a configuration in which a PC 101 and a server 103 are communicably connected by a network 102. The network 102 is a shared network or a public network that is used by many and unspecified apparatuses, such as the Internet. Therefore, the server 103 is an external apparatus on a shared network, when seen from the PC 101.

The PC 101 is a general-purpose computer, and may be in one of various forms such as a desktop type, a laptop type, and a tablet-type. The PC 101 holds image data to be subjected to image processing, and receives, from the user, an instruction related to image processing to be executed on the image data. Also, the PC 101 can communicate with the server 103 via the network 102.

The server 103 behaves as an external image processing apparatus, to the PC 101. Alternatively, the server 103 may be a cloud server that provides image processing software as a service. The server 103 applies image processing in accordance with an instruction from the PC 101 (or that has been set from the PC 101 in advance), to image data received from the PC 101, and returns, to the PC 101, the image data to which image processing has been applied. The PC 101 carries out display that is based on the image data received from the server 103.

FIG. 2 is a block diagram showing an exemplary function configuration of the PC 101. A controller 201 is a microprocessor such as a CPU, and controls operations of the blocks of the PC 101 by loading a program stored in a ROM 202 or a storage 206 to a RAM 203, and executing the program. Note that the program may also be received through the network 102.

The ROM 202 is an electrically rewritable non-volatile memory. The ROM 202 stores programs that can be executed by the controller 201, parameters required for executing programs, various setting values, GUI data, and the like.

The RAM 203 is an electrically rewritable volatile memory. The RAM 203 is used for temporally storing programs, various types of information that are used when programs are being executed, data generated by the blocks, and the like. In addition, a portion of the RAM 203 may be used as a video memory of a display 207.

A transmitter/receiver 204 is a network interface of the PC 101. The controller 201 can communicate with an apparatus (including the server 103) on the network 102 through the transmitter/receiver 204.

The image processor 205 can apply various types of image processing to image data stored in the RAM 203. For example, if the image data is data obtained through shooting by a camera, it is possible to apply preprocessing, color interpolation processing, correction processing, detection processing, and data processing. The preprocessing includes signal amplification, reference level adjustment, defective pixel correction, and the like. The color interpolation processing is processing for interpolating the values of color components that are not included in image data, and is also called demosaic processing. The correction processing includes white balance adjustment, processing for correcting the luminance of an image, processing for correcting aberration of the optical system of a lens used for shooting, processing for correcting colors, and the like. The detection processing includes processing for detecting and tracking a feature region (for example, a face region or a human body region), processing for recognizing a person, and the like. The data processing includes scaling processing, encoding and decoding processing, and the like. Note that these are examples of image processing that can be applied by the image processor 205, and do not limit image processing that can be applied by the image processor 205. Note that information that cannot be obtained from image data, such as information regarding an apparatus used for shooting, can be obtained from a data file in which image data is stored, for example.

The storage 206 is a combination of a memory card and a card reader, a hard disk drive, an SSD, or the like. The storage 206 stores data and reads out stored data under control of the controller 201.

The display 207 includes a display device such as an LCD, and performs display that is based on data written in a video memory region of the RAM 203.

An input console 208 is a general term for input devices that can be operated by the user, such as a keyboard, a touch panel, a mouse, a switch, buttons, and a dial. An operation on the input console 208 is detected by the controller 201.

Note that a basic function configuration of the server 103 may be similar to that of the PC 101.

In this embodiment, the controller 201 determines whether or not to cause the PC 101 (the controller 201 or the image processor 205) to apply image processing or entrust the server 103 to apply the image processing, according to content of the image processing to be applied.

Here, as an example of such a case, the controller 201 causes the PC 101 to apply image processing that is to be executed based on a processing level or a processing parameter in accordance with a user's instruction. The controller 201 determines that the server 103 is to apply image processing that is to be executed regardless of a user's instruction or image processing in which the user only gives an on/off instruction. Alternatively, the controller 201 determines that the PC 101 is to apply image processing that can be repeatedly applied, and the server 103 is to apply image processing that is applied only once.

Image processing that is executed regardless of a user's instruction, image processing in which the user gives only an on/off instruction, or image processing that is applied only once includes, for example, image processing that is applied due to characteristics of a device (particularly, an image sensor or a shooting lens) used during shooting. Specifically, defective pixel correction, noise reducing processing, color interpolation processing, gamma correction processing, aberration correction processing, and the like are included, but there is no limitation thereto.

In addition, image processing that is executed based on a processing level or a processing parameter in accordance with a user's instruction, or image processing that can be repeatedly applied includes, for example, image processing that is applied as so-called retouch processing. Specifically, tone curve adjustment, adjustment of hue, saturation, and brightness, white balance adjustment, and the like are included, but there is no limitation thereto.

Note that a configuration may also be adopted in which the server 103 is entrusted to apply predetermined image processing for which the processing load is large, even if the predetermined image processing is image processing that is executed based on a processing level or a processing parameter in accordance with a user's instruction, or image processing that can be repeatedly applied. In addition, a configuration may also be adopted in which, if the current processing load of the PC 101 is larger than or equal to a threshold value, the server 103 is entrusted to apply image processing that is usually applied by the PC 101.

Information regarding image processing that the server 103 is entrusted to apply and information regarding image processing that is to be applied by the image processor 205 or the controller 201 can be stored, for example, in the ROM 202 in advance. The controller 201 references the ROM 202 in accordance with image processing that is to be applied to image data, specifies a location in which the image processing is to be applied, and executes processing required for applying the image processing at the specified location. The required processing is processing for transmitting image data and information required for the image processing to the specified location, for example.

In this manner, a configuration is adopted in which the PC 101 applies image processing that is executed based on a processing level or a processing parameter in accordance with a user's instruction, or image processing that can be repeatedly applied. Accordingly, it is possible to effectively reduce the communication data amount between the PC 101 and the server 103, and to reduce the influence that processing delay caused by a mutual communication time has on the responsiveness to a user instruction.

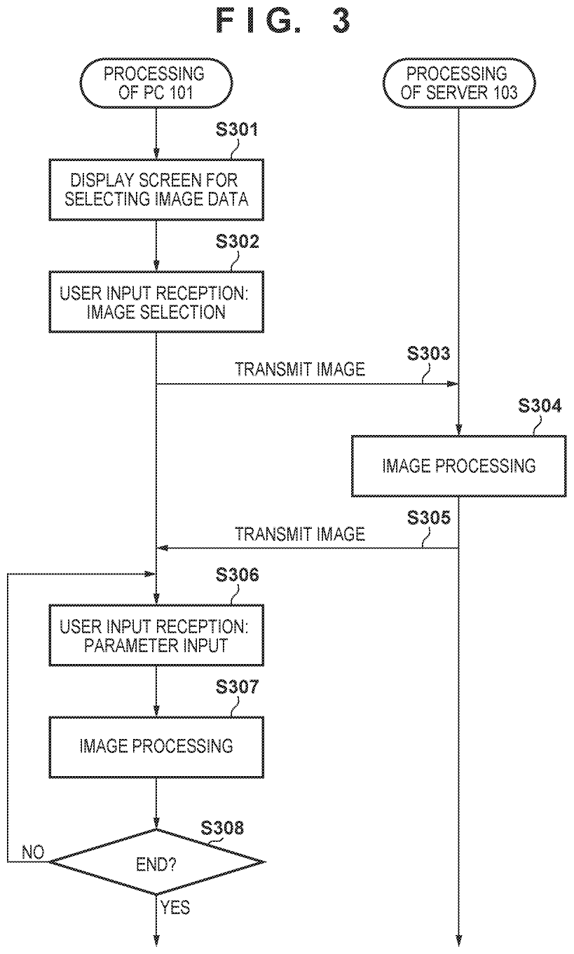

FIG. 3 is a flowchart related to operations of the image processing system 100 according to this embodiment of the invention. Processing of the PC 101 is started as a result of execution of an image processing application being instructed, for example.

In step S301, the controller 201 displays, on the display 207, a screen for selecting image data. For example, the controller 201 displays, on the display 207, a list of selectable pieces of image data stored in a predetermined directory of the storage 206, for example. The list may include items such a file name, stored time and date, and a thumbnail image for each piece of image data.

In step S302, the controller 201 detects an operation on the input console 208, and specifies image data selected by the user, in accordance with the detected operation.

In step S303, the controller 201 transmits the image data selected by the user in step S302, to the server 103 through the transmitter/receiver 204. Here, image processing that is to be necessarily applied to the image data includes image processing that is to be applied by the server 103. The controller 201 transmits information required for image processing to the server 103 along with the image data. Examples of the information required for image processing include information regarding an apparatus that shot the image data, shooting conditions, and the like. Note that image processing that is to be applied may be presented to the server 103, and, if, for example, the image processing that is to be applied is known by the server 103, content of the image processing does not need to be presented.

In step S304, the server 103 receives the image data transmitted from the PC 101, and applies image processing to the image data. In step S304, as described above, the server 103 applies, to the image data, image processing that is to be applied once. Here, as an example, image processing for correcting image quality deterioration caused by an imaging optical system and image sensor used for shooting to obtain the image data is applied. Such image processing will be described later in detail.

In step S305, the server 103 transmits, to the PC 101, the image data to which image processing has been applied.

In step S306, the controller 201 generates image data to be displayed, based on the image data received from the server 103, and displays the generated image data along with a GUI for image editing, on the display 207. The user can operate the GUI for image editing through an operation on the input console 208, so as to instruct the PC 101 to apply desired image processing such as adjustment of a saturation and a tone.

In step S307, the controller 201 controls the image processor 205 so as to apply the image processing to the image data, based on a parameter corresponding to the operation on the input console 208. The image processor 205 transmits, to the controller 201, the image data to which the image processing has been applied. The controller 201 updates the display using the image data to which the image processing has been applied.

In step S308, when the user gives an instruction to end image processing, through the input console 208, the controller 201, for example, stores image data subjected to image processing, in the storage 206, and ends the processing. On the other hand, if no instruction to end image processing is detected through the input console 208, the controller 201 waits for input of another instruction through the input console 208.

Note that FIG. 3 illustrates that the server 103 first applies image processing once, and the PC 101 then applies image processing. However, if image processing for which the processing load is large is instructed by the user in step S306, or when the load of the PC 101 is large, the server 103 may be further entrusted to apply image processing.

Next, examples of image processing that is applied by the server 103 in step S304 and image processing that is applied by the PC 101 in step S307 will be described.

First, image processing for correcting aberration caused by an imaging optical system used for shooting to obtain image data and image processing for correcting noise caused by an image sensor will be described as examples of image processing that can be applied by the server 103 in step S304.

Image processing for correcting aberration will be described. Aberration occurs due to the shapes and materials of optical members of a lens unit used for shooting, and conditions such as a zoom position in the case of a zoom lens. Therefore, a correction value for correcting data of each pixel constituting the image data can be specified based on information regarding the type of the lens unit, shooting conditions (particularly, an aperture value), and a zoom position (angle of view). Correction values may be held as a table in the server 103, or may also be obtained from another apparatus on the network 102. For example, a known method such as that described in Japanese Patent Laid-Open No. 2011-217087 can be used as correction values and a correction method that uses the correction values.

Next, image processing for correcting noise will be described. Noise is generated due to characteristics of an image sensor used for shooting to obtain image data, and conditions such as shooting conditions (particularly, shooting sensitivity). Therefore, a correction value for correcting data of each pixel constituting the image data can be specified based on information regarding the type of image sensor and shooting conditions (particularly, shooting sensitivity). Correction values may be held as a table in the server 103, or may also be obtained from another apparatus on the network 102. A known method such as that described in Japanese Patent Laid-Open No. 2013-026669 can be used as correction values and a correction method that uses the correction values.

Image processing for correcting aberration and noise is processing that requires a large calculation amount for applying two-dimensional space filter processing that uses adjacent pixels, for each pixel. In addition, basically, it suffices for such image processing to be applied to image data once. The image processing capability of the server 103 that provides an image processing service on the network 102 is usually higher than that of the PC 101. Therefore, the effect of reducing the processing time by such image processing being applied by the server 103 is great.

Here, in step S304, the server 103 applies both image processing for correcting aberration and image processing for correcting noise, but may also apply one of image processing for correcting aberration and image processing for correcting noise. In addition, image processing for the correcting image quality deterioration caused by an imaging optical system or an image sensor, which can be applied by the server 103, is not limited thereto. For example, it is also possible to apply other image processing such as image processing for correcting a decrease in the sharpness due to a diffraction phenomenon caused by a diaphragm included in the imaging optical system, and image processing for correcting a decrease in the sharpness caused by an optical low-pass filter. Furthermore, image processing that is applied basically once, such as color interpolation processing can be applied by the server 103.

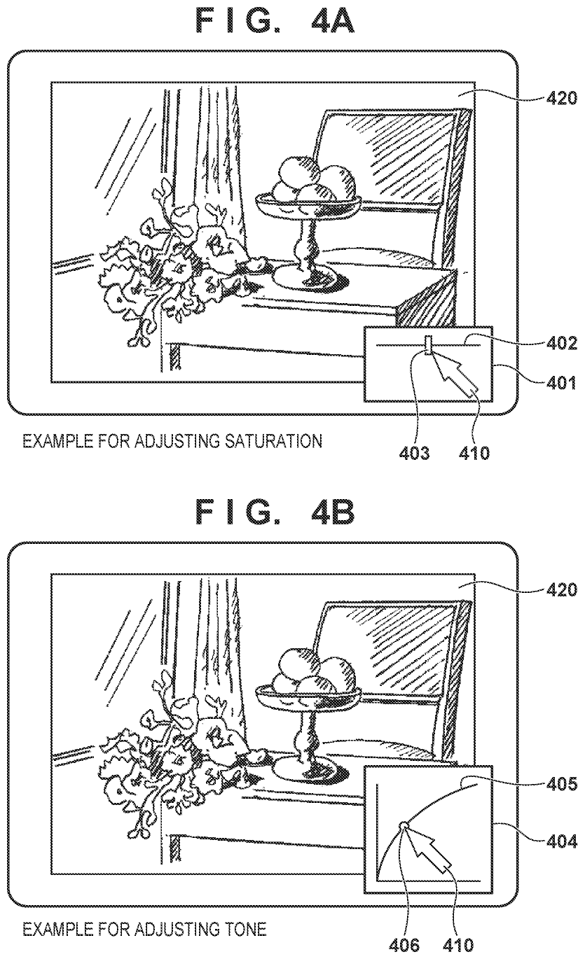

Next, image processing for adjusting a saturation and image processing for adjusting a tone will be described as examples of image processing that can be applied by the PC 101 in step S307. FIG. 4A shows an example of a GUI for saturation adjustment from among GUIs for image editing presented by the PC 101 in step S306.

A GUI 401 for saturation adjustment includes a slider 402. When an operation of moving a knob 403 of the slider 402 performed on the input console 208 (for example, a moving operation of a cursor 410 pointing at the knob 403) is detected, the controller 201 moves the display position of the knob 403 in accordance with the operation. Note that, if the display 207 is a touch display, the controller 201 may detect a touch operation of moving the knob 403 (for example, a drag operation of the knob 403). Subsequently, the controller 201 determines a saturation corresponding to the display position of the knob 403 when no more operation is detected, and instructs the image processor 205 to apply the changed saturation to image data corresponding to a display image 420. The image processor 205 applies processing for changing the saturation, to the image data. In addition, the image processor 205 generates new image data to be displayed, based on the changed image data, and updates the video memory of the RAM 203 using the new image data to be displayed. Accordingly, the user can check the display image 420 to which the saturation instructed by the user him/herself has been applied.

FIG. 4B shows an example of a GUI for tone adjustment, from among the GUIs for image editing presented by the PC 101 in step S306. A GUI 404 for tone adjustment includes a graph of a tone curve 405. When an operation of moving a control point 406 on the tone curve 405 performed on the input console 208 (for example, a moving operation of the cursor 410 pointing at the control point 406) is detected, the controller 201 moves the display position of the control point 406 in accordance with the operation. Note that, if the display 207 is a touch display, the controller 201 may detect a touch operation of moving the control point 406 (for example, a drag operation of the control point 406). When a moving operation in the right-left direction is detected, the controller 201 moves only the control point 406 on the tone curve. Also, when a moving operation in the up-down direction is detected, the controller 201 moves the position of the control point 406 vertically, and deforms the tone curve in accordance with the position of the moved control point 406. Note that there may be a plurality of control points 406.

The controller 201 then instructs the image processor 205 to apply tone conversion that is based on the shape of the tone curve when no more operation is detected, to image data corresponding to the display image 420. The image processor 205 applies processing for changing the tone characteristics of the image data. Also, the image processor 205 generates new image data to be displayed, based on the changed image data, and updates the video memory of the RAM 203 using the new image data to be displayed. Accordingly, the user can check the display image 420 to which a change in the tone characteristics instructed by the user him/herself has been applied.

In many cases, adjustment of a saturation and a tone is performed by trial and error while checking display image, so as to obtain an intended result. Accordingly, image processing related to adjustment of a saturation and a tone is repeatedly executed in many cases, and, considering the usability, it is desirable that a result of adjustment is immediately converted into a display image. Furthermore, image processing related to adjustment of a saturation and a tone can be carried out using information on only pixels to be processed, and thus its calculation amount is small compared with correction of aberration and the like. Therefore, the advantage of the PC 101 applying image processing is larger than that of the server 103 applying the image processing while repeating transmission/receiving of image data.

Note that image processing that is carried out by the PC 101 may be adjustment of one of or both a saturation and a tone. In addition, the PC 101 may also apply, not limited to adjustment of a saturation and a tone, at least one of any other types of image processing that are executed by trial and error in many cases, such as adjustment of hue, contrast, brightness, and sharpness, as well as resizing.

As described above, according to this embodiment, in an image processing apparatus communicably connected to an external apparatus, determination is made whether to entrust the external apparatus to apply image processing to image data, or to apply the image processing by itself, according to the content of the image processing to be applied. Therefore, it is possible to suppress an increase in the processing time caused by a time required for communication with the external apparatus relative to a case of entrusting the external apparatus to apply all the image processing.

### Second Embodiment

Next, a second embodiment of the present invention will be described. In the first embodiment, determination is performed on whether the PC 101 is to apply image processing or the server 103 is to apply the image processing, in accordance with the content of the image processing mainly from a viewpoint of shortening of the processing time. In this embodiment, a case will be described in which communication with the server 103 is charged in a metered rate system that is based on the data amount. The configuration of the image processing system 100 and the configuration of the PC 101 may be similar to those of the first embodiment, and thus this embodiment will be described mainly with a focus on operations unique to this embodiment.

According to this embodiment, a configuration is adopted in which, if the data format changes in a process in which the server 103 sequentially applies a plurality of types of image processing to image data, image processing that is applied by the server 103 is stopped before the data format changes to a data format for which the data amount is large. Alternatively, the server 103 applies image processing in a range in which the data format of the image data after image processing, which is to be transmitted from the server 103 to the PC 101, does not become a data format for which the data amount is larger than that of the data format of the image data before image processing, which is transmitted from the PC 101 to the server 103.

For example, assume that image data is transmitted from the PC 101 to the server 103 in a first data format, and there are three types of image processing, namely image processing A to image processing C that can be applied to image data by the server 103 in the order of A, B, and C. Also, assume that, according to the image processing A and the image processing B, a processing result is output in the first data format, and, according to the image processing C, a processing result is output in a second data format for which the data amount is larger than that of the first data format. In this case, the server 103 applies the image processing A and the image processing B from among the image processing A to the image processing C, and the PC 101 performs the image processing C. If the server 103 applies all of the image processing A to the image processing C, image data that is returned from the server 103 to the PC 101 is image data in the second data format, and the transmission data amount increases to be larger than that of the first data format. If the server 103 applies up to the image processing B, image data that is returned from the server 103 to the PC 101 can be in the first data format, and the communication data amount can be reduced.

For example, if image data is data obtained through shooting, the data format of the image data may be different depending on whether the image data is RAW data or data subjected to developing processing. RAW data obtained through shooting that uses an image sensor provided with a primary-color Bayer array color filter includes one color component out of R (red), G (green), and B (blue) components for each pixel, with the depth of 12 bits/pixel or 14 bits/pixel in many cases.

On the other hand, image data subjected to developing processing (color interpolation processing) includes three (different) RGB components for each pixel with the depth of 8 bits/component (24 bits/pixel), or a Y component and U or V component with the depth of 8 bits/component (16 bits/pixel), in many cases.

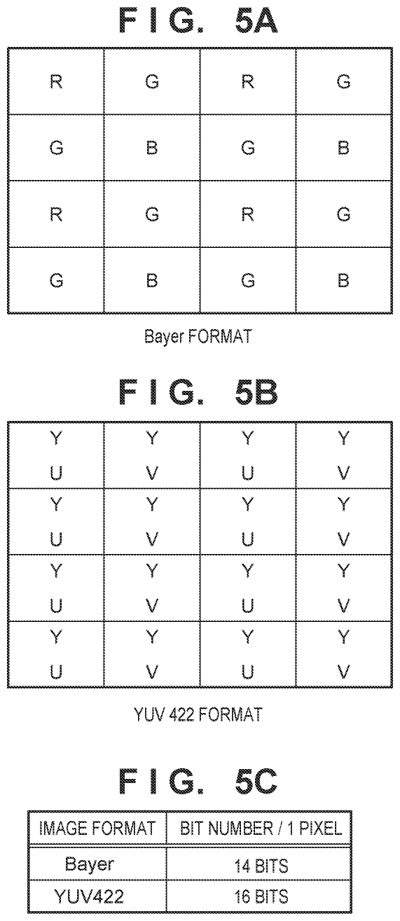

FIGS. 5A to 5C schematically show examples of respective data formats. Here, a data format in which there is one color component for each pixel at a 14-bit depth is defined as a Bayer format (14 bits/pixel), and a data format in which there are a Y component and U or a V component for each pixel at a 8-bit depth is defined as a YUV422 format (16 bits/pixel).

For example, as described in the first embodiment, a case is considered in which both image processing for correcting aberration and image processing for correcting noise are applied to image data. Here, image processing for correcting aberration is performed on image data in the Bayer format, and image processing for correcting noise is performed on image data in the YUV422 format.

In this case, in step S303 in the flowchart shown in FIG. 3, image data in the Bayer format is transmitted from to the PC 101 to the server 103. Subsequently, in step S304, the server 103 performs image processing for correcting aberration, and returns image data in the Bayer format in step S305. Then, before executing step S306, the controller 201 of the PC 101 causes the image processor 205 to apply image processing for correcting noise to the image data in which aberration has been corrected. The image processor 205 converts the image data from the Bayer format into the YUV422 format, and then applies image processing for correcting noise. If image data in the Bayer format is obtained as a result of image processing for correcting noise, it is sufficient to apply image processing similarly to the first embodiment.

Note that, also in this embodiment, information regarding image processing that the server 103 is entrusted to apply and information regarding image processing that is applied by the PC 101 are stored in the ROM 202 in advance. In this embodiment, it is possible to perform determination, in advance, on image processing that the server 103 is entrusted to apply and image processing that is applied by the PC 101, in accordance with the data format of image data that will be output as a result of image processing. The image processing that the server 103 is entrusted to apply can be performed on image fata in a data format other than a data format for which the data amount is the largest, from among a plurality of data formats. Note that, if the format of image data that is finally obtained is not in a data format for which the data amount is the largest, each of a plurality of types of image processing that are continuously applied can be entrusted to the server 103 to apply, regardless of a format of image data while processing is being performed.

According to this embodiment, a range of image processing that is applied by an external apparatus is kept in a range in which the data amount does not increase to be larger than that before image processing. Therefore, when entrusting the external apparatus to apply image processing, it is possible to avoid image data after image processing for which the data amount has increased to be larger than that before the image processing, from being returned from the external apparatus. Therefore, if communication with the external apparatus is charged in a metered rate system, the communication cost can be saved.

Note that a configuration may also be adopted in which, if image processing that is performed by the server 103 is subject to fees, the server 103 applies only image processing that cannot be performed by the PC 101, or takes too much time. In this case as well, (information regarding) image processing that is to be entrusted to the server 103 can be registered in the ROM 202 in advance.

### Other Embodiments

In the image processing system 100 according to the embodiments of the invention, image processing that is not applied by the PC 101 is applied by the server 103. However, image processing that has been described as being to be applied by the PC 101 can be alternatively executed by a second external apparatus that is before the network 102 seen from the PC 101 (for example, on a local network or directly connected). In this case, image data needs to be communicated between the PC 101 and the second external apparatus in both directions. However, the communications between the PC 101 and the second external apparatus are faster and more stable than the communications between the PC and the server 103 through the network 102. Accordingly, the processing delay due to the communications and its variation are small.

Embodiment(s) of the present invention can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-199242, filed on Oct. 31, 2019, which is hereby incorporated by reference herein in its entirety.

What is claimed is:

1. An image processing apparatus comprising:
one or more processors that execute a program stored in a memory to function as:
an image processing unit configured to apply image processing to image data;
a communication unit configured to communicate with an external apparatus; and
a control unit configured to control whether image processing for the image data is to be applied at the image processing unit or at the external apparatus, based on content of the image processing or an amount of data to be communicate with the external apparatus.

2. The image processing apparatus according to claim 1,
wherein the control unit is configured to determine that image processing that is applied to the image data in accordance with a user's instruction is to be applied at the image processing unit.

3. The image processing apparatus according to claim 2,
wherein the image processing that is applied to the image data in accordance with a user's instruction includes at least one of: adjusting saturation, tone, hue, contrast, brightness or sharpness; and resizing.

4. The image processing apparatus according to claim 1,
wherein the control unit is configured to determine that image processing that is to be applied to the image data just one time is to be applied at the external apparatus.

5. The image processing apparatus according to claim 1,
wherein the control unit is configured to determine that image processing for correcting image quality deterioration caused by an imaging optical system or an image sensor is to be applied at the external apparatus.

6. The image processing apparatus according to claim 5,
wherein the image processing for correcting image quality deterioration caused by an imaging optical system or an image sensor includes at least one of: image processing for correcting aberration; image processing for correcting noise; image processing for correcting a decrease in sharpness due to a diffraction phenomenon caused by a diaphragm included in the imaging optical system; and image processing for correcting a decrease in sharpness caused by an optical low-pass filter.

7. The image processing apparatus according to claim 1,
wherein the control unit, in case where the image data is transmitted to the external apparatus via the communication unit, is configured to
control the communications unit so that the image data is transmitted in a first data format, and
control the external apparatus so as to apply image processing that the image data applied the image processing is in the first data format.

8. The image processing apparatus according to claim 7,
wherein the image processing unit is configured to apply image processing to image data in a second data format for which a data amount is larger than that of the first data format.

9. The image processing apparatus according to claim 1,
wherein the external apparatus is on a shared network.

10. The image processing apparatus according to claim 9,
wherein the control unit is configured to control another external apparatus that is before the shared network seen from the image processing apparatus, to alternatively apply image processing that is to be applied by the image processing unit.

11. An image processing method that is executed by an image processing apparatus that includes an image processor that applies image processing to image data, the method comprising
controlling whether image processing for the image data is to be applied at the image processor or at an external apparatus with which the image processing apparatus can communicate, based on content of the image processing or an amount of data to be communicated with the external apparatus.

12. A computer-readable medium that stores a program causing a computer to function as an image processing apparatus comprising:
an image processing unit configured to apply image processing to image data;
a communication unit configured to communicate with an external apparatus; and
a control unit configured to control whether image processing for the image data is to be applied at the image processing unit or at the external apparatus, based on content of the image processing or an amount of data to be communicate with the external apparatus.
